(19) United States
(12) Patent Application Publication
(10) Pub. No.: US 2018/0082287 A1
(43) Pub. Date: Mar. 22, 2018

(54) CRYPTOCURRENCY LOCK FOR ONLINE ACCOUNTS

(71) Applicant: Howard H. Sheerin, Scottsdale, AZ (US)

(72) Inventor: Howard H. Sheerin, Scottsdale, AZ (US)

(21) Appl. No.: 15/268,612

(22) Filed: Sep. 18, 2016

(51) Int. Cl. G06Q 20/38; H04L 9/30; G06Q 20/10; G06K 7/14

(52) U.S. Cl. CPC G06Q 20/3821; G06K 7/1417; G06Q 20/108; H04L 9/30

(57) ABSTRACT

A method of managing an online account is disclosed comprising receiving a public cryptocurrency address using a network of computers, checking a balance associated with the public cryptocurrency address using the Internet, and when the checked balance of the public cryptocurrency address has been reduced from a non-zero value, enabling access to at least part of the online account. Any suitable cryptocurrency may be employed, such as bitcoin or ethereum.

### BACKGROUND

There is a well-known desire to maintain security of certain online accounts, particularly financial accounts such as bank accounts, credit card accounts, brokerage accounts, currency exchange accounts, online gaming accounts, etc., as well as other types of accounts that may store valuable information, such as hospital databases, legal databases, etc., or infrastructure accounts, such as utility services, military services, etc. Conventionally an online account may be protected with certain login information, which may be as simple as a user_name/password, or may be more sophisticated, such as two-factor authentication which augments the user_name/password with a verification code transmitted to a user's cell phone.

The service providers responsible for maintaining the online accounts typically employ complex security measures to safeguard the login information to prevent hackers from breaking into and stealing funds and/or valuable information from the accounts. Nevertheless, there is always the possibility and actual instances of hackers circumventing the safeguards employed by service providers leading to theft from online accounts. There is also the possibility and actual instances of hackers discovering a user's login information from the users themselves, such as through email phishing techniques and other forms of nefarious communication and malware. There is, therefore, a need to improve the security measures employed to safeguard online accounts of any kind.

### BRIEF DESCRIPTION OF THE DRAWINGS

FIG. 1A shows a computer according to an embodiment for executing a flow diagram, wherein a balance associated with a public cryptocurrency address is checked using the Internet, and access to at least part of an online account is enabled based on the checked balance of the public cryptocurrency address.

FIG. 1B illustrates an embodiment wherein the cryptocurrency is bitcoin, the balance associated with a public bitcoin address is initialized with one satoshi in order to lock at least part of an online account, and the satoshi is transferred out of the public bitcoin address using a corresponding private bitcoin key in order to unlock at least part of the online account.

FIG. 2A is a flow diagram according to an embodiment executed at a user side of a computer network for creating a new online account and for transmitting a public cryptocurrency address to a service provider computer that manages the online account.

FIG. 2B is a flow diagram according to an embodiment executed at a service provider side of a computer network for checking the balance associated with the user public cryptocurrency address in order to determine whether the user has unlocked at least part of the online account.

FIG. 3A is a flow diagram according to an embodiment executed at a user side of a computer network wherein after unlocking part of an online account using a first public cryptocurrency address, the user transmits a second public cryptocurrency address to the service provider in order to re-secure the account.

FIG. 3B is a flow diagram according to an embodiment executed at a service provider side of a computer network wherein the service provider waits for the second public cryptocurrency address to be transmitted by the user before enabling access to a secure area of an account.

FIG. 4 is a flow diagram according to an embodiment executed at a service provider side of a computer network wherein the public cryptocurrency address received from the user is used to encrypt at least part of the data associated with the online account in order to authenticate the public cryptocurrency address at a later time.

FIG. 5 is a flow diagram according to an embodiment executed at a service provider side of a computer network wherein a user's login information may consist of only a public cryptocurrency address.

FIG. 6 is a flow diagram according to an embodiment executed at a service provider side of a computer network wherein a user unlocks a secure area of an online account by transferring cryptocurrency from the user public cryptocurrency address to a service provider (SP) public cryptocurrency address, and the transfer is verified by the service provider in order to enhance the security of the online account.

### DETAILED DESCRIPTION

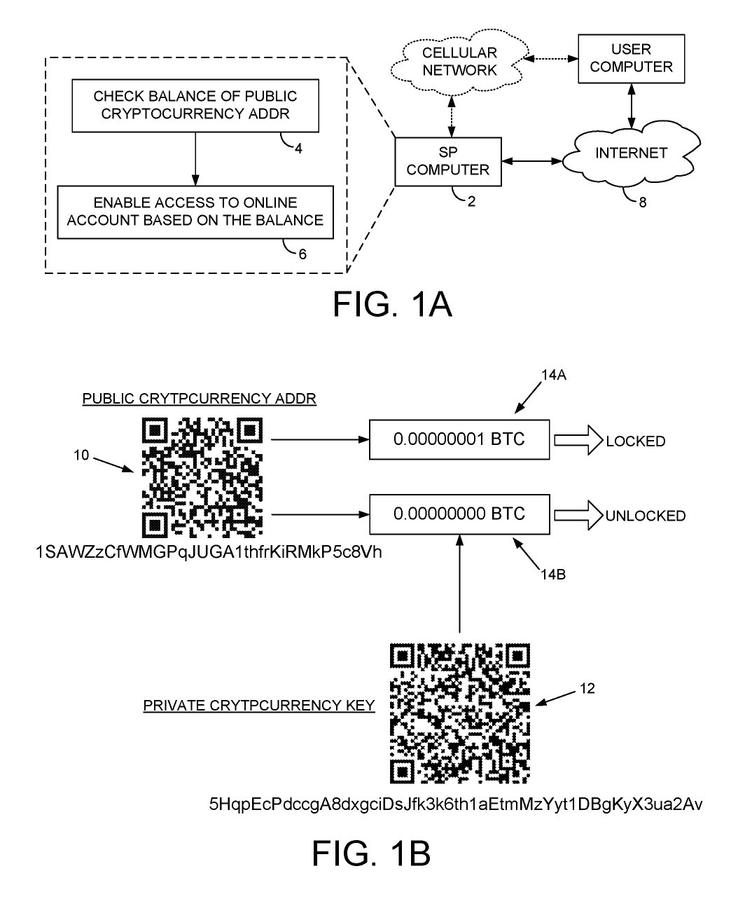

FIG. 1A shows a computer 2 according to an embodiment configured to manage an online account by executing the flow diagram as shown, wherein a balance associated with a public cryptocurrency address is checked (block 4) using the Internet 8, and access to at least part of the online account is enabled based on the checked balance of the public cryptocurrency address (block 6).

Any suitable cryptocurrency may be employed in the embodiments disclosed herein, such as bitcoin or ethereum. The characteristics and implementation of a suitable cryptocurrency, such as bitcoin, are well known. In general, a cryptocurrency is a medium of exchange using cryptography to secure the transactions and to control the creation of additional units of the currency. A public database referred to as a blockchain is maintained by servers on the Internet in order to verify, facilitate, and record every transaction. The distributed nature of the blockchain over multiple nodes in the network together with a suitable form of timestamping (e.g., proof-of-work) ensures the security and authenticity of the database. Each unit of cryptocurrency (e.g., each bitcoin or fraction of bitcoin) is assigned to a public cryptocurrency address that is recorded in the blockchain, wherein the unit of currency may be transferred out of the public address (e.g., to another public address) using a private cryptocurrency key held by the current “owner” of the unit. In addition, the current balance of any particular public cryptocurrency address may be checked by any entity by executing a query of the blockchain database. In the embodiments described herein, these general characteristics of a cryptocurrency are exploited in order to increase the security of accessing any suitable online account.

An online account is any account that may be accessed over a network of computers, such as the Internet or a cellular network. Examples of online accounts include, but is not limited to, bank accounts, credit card accounts, brokerage accounts, currency exchange accounts, online gaming accounts, etc., as well as other types of accounts that may store valuable information, such as hospital databases, legal databases, etc., or infrastructure accounts, such as utility services, military services, etc. In one embodiment, a cryptocurrency may be used to augment the security information used to access an online account, such as augmenting a user_name/password combination which may or may not include any suitable two-factor authentication. In another embodiment, a cryptocurrency may be used in place of conventional security information, such as replacing a user_name/password with a public cryptocurrency address. That is in one embodiment, the only security information transmitted by a user to a service provider in order to access an online account may be a public cryptocurrency address.

In one embodiment, a public cryptocurrency address may be used to secure an entire account. For example, in one embodiment a public cryptocurrency address may be required in order for a user to login to an online account. In another embodiment, a public cryptocurrency address may be used to secure part of an online account, such as enabling access to a subset of data associated with the account, or enabling certain features of an online account. For example, a cryptocurrency exchange account may have associated with it a cold storage area (i.e., a vault) for storing information representing cryptocurrency that is stored offline. In one embodiment, access to the cold storage area may be enabled based on a public cryptocurrency address. In another embodiment, a public cryptocurrency address may enable a particular feature of an online account, such as the ability to transfer funds out of an account (cryptocurrency account, bank account, brokerage account, etc.). In yet another embodiment, a public cryptocurrency address may be associated with and enable a single transaction associated with an online account, such as a single transfer of funds out of the account.

FIG. 1B illustrates an embodiment for managing an online account, wherein in this example the balance associated with a public cryptocurrency address is conceptually used to “lock” or “unlock” access and/or functionality of at least part of an online account. In FIG. 1B, a public cryptocurrency address 10 and a corresponding private cryptocurrency key 12 are generated using any suitable technique (the private key and public address shown in FIG. 1B are bitcoin for illustration only). For example with bitcoin, a public bitcoin address and private bitcoin key may be generated using the BitAddress.org website. In one embodiment, the user of an online account generates the public cryptocurrency addresses and private cryptocurrency keys in a manner such that only the user knows, holds, and maintains the private cryptocurrency key. In one embodiment, the balance 14A associated with the public cryptocurrency address 10 may be initialized to a non-zero value. For example, in one embodiment a small unit of currency (e.g., a satoshi in bitcoin) may be transferred to the balance of the public cryptocurrency address. In one embodiment, the user of an online account may initialize the balance of the public cryptocurrency address, and in another embodiment, a service provider may initialize the balance after the user transmits the public cryptocurrency address to the service provider.

In the example of FIG. 1B, the balance 14A of the public cryptocurrency address 10 is initialized to one satoshi or 0.00000001 of a bitcoin. Once the balance has been initialized to a non-zero value, the only way the balance may be reduced (via an outgoing transfer) is with the private cryptocurrency key 12 which is known, in one embodiment, only by the user of the online account. Accordingly, as long as the balance of the public cryptocurrency address is not reduced, the service provider will deny access and/or features of at least part of the online account. When the user desires access to the secure part of the account, in one embodiment the user employs the private cryptocurrency key 12 to reduce the balance associated with the public cryptocurrency address 10. In the example shown in FIG. 1B, the single satoshi may be transferred out of the public cryptocurrency address 10 such that the balance 14B is reduced to zero, thereby placing the balance of the public cryptocurrency address in an “unlocked” state. When the service provider for the online account checks the balance for the public cryptocurrency address 10 and sees that the balance has been reduced, the service provider enables access to the secure part of the online account. In this manner, the private cryptocurrency key 12 becomes a key used to access at least part of an online account, wherein in one embodiment the private cryptocurrency key 12 may be known only to a single entity (e.g., the user), thereby avoiding the need to store this private security information at the service provider.

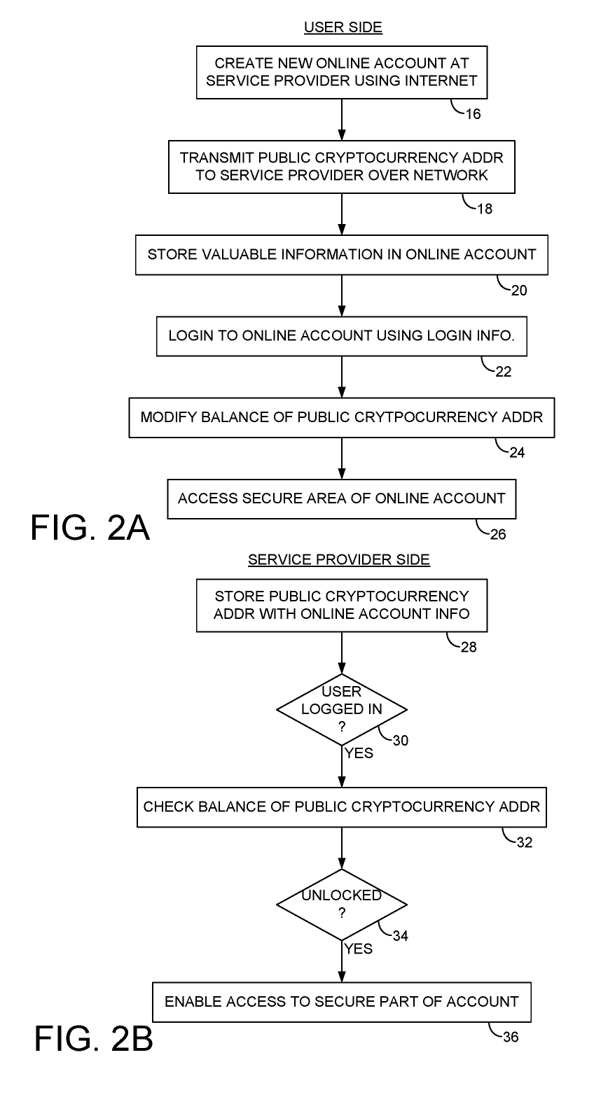

FIG. 2A is a flow diagram according to an embodiment executed at the user side of a computer network for managing an online account. In this embodiment, the user creates a new online account over the Internet (block 16), for example, by visiting a website or executing a smartphone app of any suitable service provider (bank, brokerage, exchange, utility, hospital, military, etc.). In one embodiment, the user may transmit security information for accessing the online account, such as a user_name/password. In another embodiment described below, the account security information transmitted to the service provider may consist of only a public cryptocurrency address, that is, an online account may be associated with a public cryptocurrency address rather than with a specific user. At some point, the user transmits a public cryptocurrency address to the service provider (block 18) over a network such as the Internet, or in another embodiment, using a text messaging feature of a cellular network.

Valuable information is stored (or associated with) the online account (block 20), such as the user transferring funds or other valuable information to the account. When the user desires to access the account, the user logs into the account (block 22), wherein in one embodiment, logging into an account may include setting up a secure communication link between the user and the service provider. In one embodiment, logging into the online account may include entering a user_name/password and may also include a suitable two-factor authentication. Once the user has logged into the online account, a certain subset of data and/or a certain subset of features may be disabled due to the public cryptocurrency address reflecting a particular balance (e.g., a non-zero balance). When the user desires to enable access to the secure part of the online account, the user employs the private cryptocurrency key in order to modify (e.g. reduce) the balance associated with the public cryptocurrency address (block 24). For example, the user may transfer all or part of the balance from the account public address to a different public address, thereby reducing the balance of the account public address. Once the balance of the account public address has been modified, the user is allowed to access the secure area (or secure feature) of the online account (block 26).

In one embodiment, the secure communication link during the login sessions helps maintain security of the online account while the secure area or feature of the online account is unlocked and accessed by the user. In an embodiment described below, a new public cryptocurrency address may be used to re-secure at least part of an online account, for example, after a user finishes accessing the secure area (e.g., when logged off of the account).

FIG. 2B is a flow diagram according to an embodiment executed at a service provider side of a computer network responsible for maintaining online accounts for users. In one embodiment, the service provider stores the public cryptocurrency address received from the user together with other login information of the user (e.g., user_name/password) and associates the information with the online account (block 28). In another embodiment described below, the service provider may store and associate only the public cryptocurrency address received from the user with the online account. After the user logs into the online account at block 30 (or as part of the login process), the service provider checks the balance associated with the public cryptocurrency address assigned to the account (block 32). If the checked balance indicates the user has unlocked the secure area of the account using the corresponding private cryptocurrency key (block 34), the service provider enables access to the secure area of the account (block 36).

In one embodiment, once the balance of a public cryptocurrency address has been modified using the private cryptocurrency key in order to unlock a secure area of an online account, the private cryptocurrency key may be considered as unsecure since it was transmitted over the Internet in order to execute the balance transfer.

Accordingly, in one embodiment each time a user accesses a secure area (or feature) of an account, the user transmits a new public cryptocurrency address to the service provider in order to re-secure the secure area of the account.

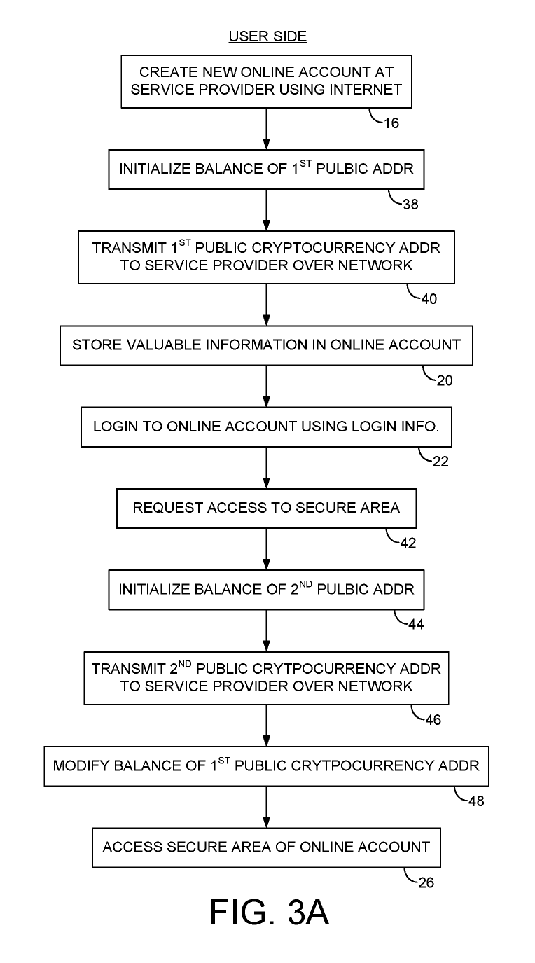

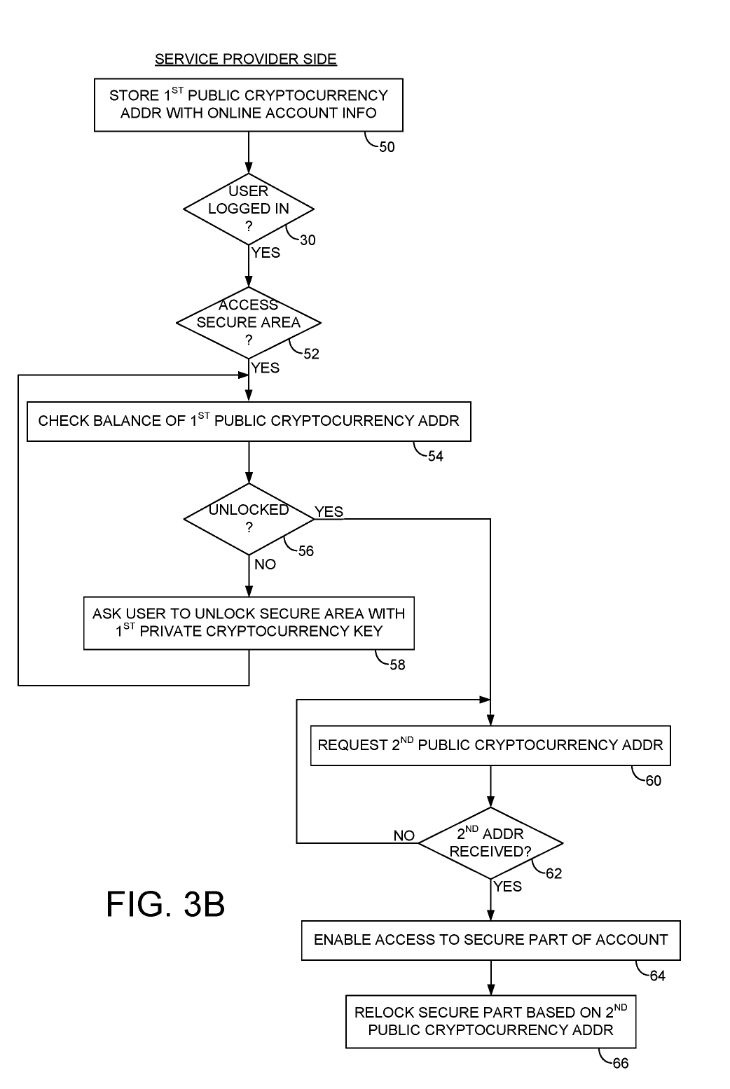

This embodiment is understood with reference to the flow diagram of FIG. 3A which is executed at the user side of a computer network for managing an online account. After creating a new online account (block 16), the user initializes the balance of a first public cryptocurrency address, for example, by transferring a small amount of cryptocurrency to the first public cryptocurrency address (block 38) as illustrated in FIG. 1B. The user transmits the first public cryptocurrency address to the service provider over a network of computers (block 38), wherein the network of computers may comprise the Internet and/or a cellular network.

When the user logs into the account, the user transmits a request to the service provider to access the secure area of the online account (block 42). In addition, the user initializes a balance of a second public cryptocurrency address (block 44) and transmits the second public cryptocurrency address to the service provider (block 46), for example, in connection with the request to access the secure area of the account. The user modifies the balance of the first public cryptocurrency address using the corresponding private cryptocurrency key (block 48) in order to unlock the secure area of the online account. As described below, in one embodiment the service provider uses the second public cryptocurrency address to re-secure (re-lock) the secure area of the online account once the user is finished accessing the secure area (e.g., when the user finishes a transaction or when the user is logged off).

FIG. 3B is a flow diagram according to an embodiment executed at the service provider side of a computer network responsible for maintaining online accounts for users. The first public cryptocurrency address received from a user is stored and associated with the user's online account (block 50). After (or when) a user logs into an account, the user transmits a request to access the secure area of the account (block 52). In response to the request, the service provider checks the balance associated with the first public cryptocurrency address (block 54). If the checked balance indicates the secure area of the account is locked (block 56), the service provider transmits a request to the user to unlock the secure area using the first private cryptocurrency key corresponding to the first public cryptocurrency address (block 58). The flow diagram is then re-executed from block 54 until the balance associated with the first public cryptocurrency address indicates the secure area has been unlocked. If a second public cryptocurrency address has not yet been received from the user, the service provider sends a request to the user to transmit a second public cryptocurrency address (block 60), and in the embodiment of FIG. 3B, the service provider may keep the secure area of the account locked (block 62) until the user transmits the second public cryptocurrency address. After receiving the second public cryptocurrency address from the user, the service provider enables access to the secure area of the account (block 64). When access to the secure area of the account is completed, the service provider re-secures (re-locks) the secure area of the account using the second public cryptocurrency address (block 66).

Any suitable technique may be employed by the service provider to check the balance associated with a public cryptocurrency address, and thereby determine whether a secure area of an online account is locked. In one embodiment, the service provider may query the blockchain database of the cryptocurrency directly by employing any suitable, well known techniques. In another embodiment, the service provider may utilize an application of a third party provider, such as with the smartphone app “Bitcoin Balance” or other similar app. With Bitcoin Balance, for example, the service provider may provide as input the public cryptocurrency address, wherein the app then returns the balance associated with the public cryptocurrency address.

In the flow diagram of FIG. 3A, the user may initialize the balance of the public cryptocurrency address in order to configure it into the locked state (e.g., by transferring a small amount to the public cryptocurrency address as shown in FIG. 1B). In another embodiment, the service provider may initialize the public cryptocurrency address in order to configure it into the locked state. For example, the user may generate a public cryptocurrency address which typically has a default zero balance, and then transmit the zero-balance address to the service provider. The service provider may then initialize the balance of the public cryptocurrency address to any suitable value that may represents any suitable characteristic. For example, the service provider may initialize the balance of a public cryptocurrency address to particular values that may reflect different states, or different types of accounts, or different parts of the online account to secure, or any other information that may be useful to the service provider in maintaining the online account.

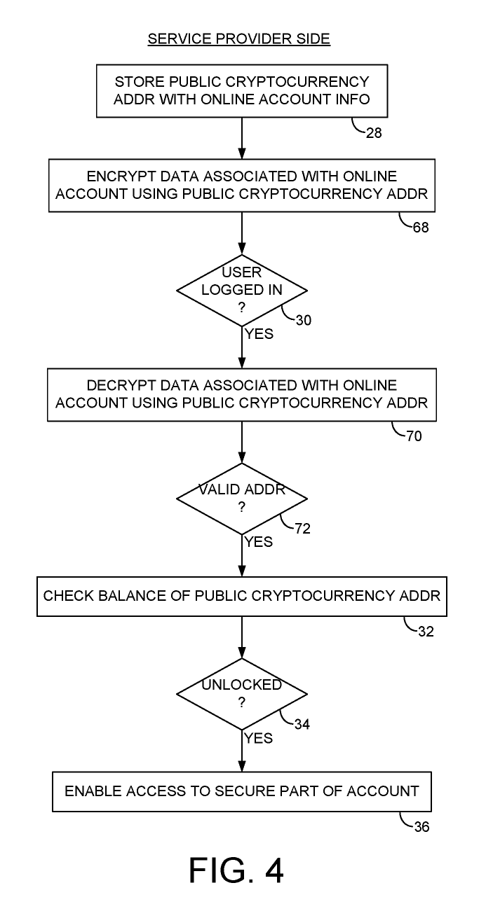

In one embodiment, the service provider may use the public cryptocurrency address associated with an account to verify that the public cryptocurrency address has not been hacked, thereby preventing the secure area of the account from being unlocked based on an invalid public cryptocurrency address. This embodiment is understood with reference to the flow diagram of FIG. 4 which is an extension of the flow diagram of FIG. 2B. When the service provider receives a valid public cryptocurrency address from a user (e.g., over a secure communication link), the service provider may encrypt at least some of the data associated with the online account using the public cryptocurrency address (block 68). When the user logs into the account at a later time (block 30), the service provider uses the public cryptocurrency address that is associated with the account to decrypt the data encrypted at block 68 (block 70). If the data fails to decrypt correctly, it indicates that the public cryptocurrency address was changed (hacked), and therefore the address is considered invalid (block 72). If the data decrypts correctly, it means the public cryptocurrency address associated with the account is valid, and therefore access to the secure area of the account is enabled as long as the checked balance of the public cryptocurrency address indicates the secure area has been unlocked by the user.

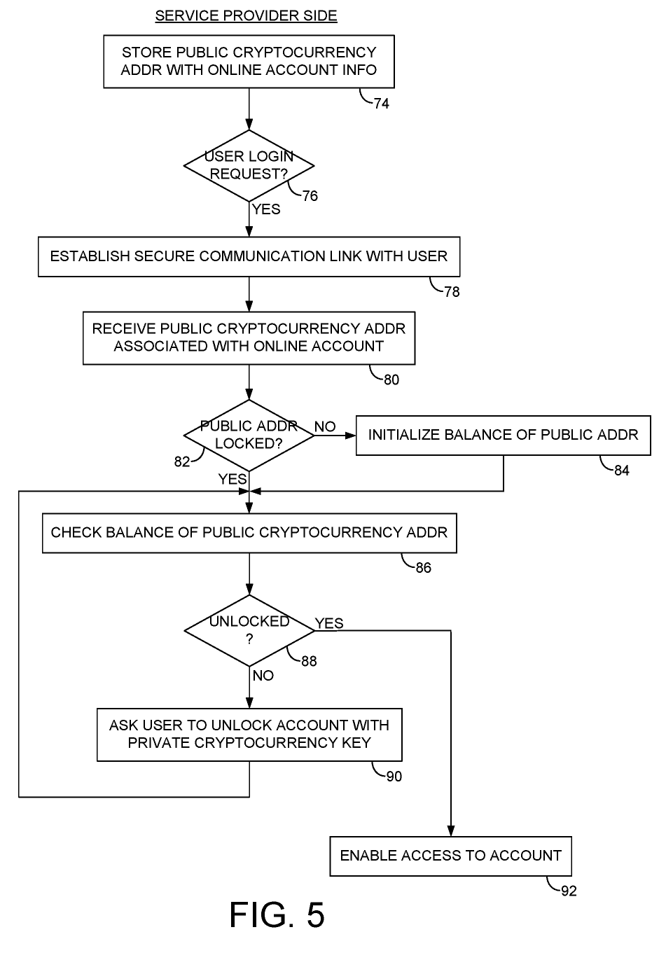

FIG. 5 is a flow diagram according to an embodiment wherein the user login information may consist only of a public cryptocurrency address generated by the user. For example, when a user visits a “new user account” page of a website or app, the service provider may request only a public cryptocurrency address in order to open a new account. The public cryptocurrency address received by the service provider from the user is then associated with the online account (block 74), and optionally used to encrypt at least part of the data associated with the account as described above. When the user wants to log into the account (block 76), the user may visit a “login” page of a website or app in order to establish a secure communication link with the service provider (block 78). The user then transmits the public cryptocurrency address associated with the account to the service provider, and when the service provider receives the public cryptocurrency address (block 80), the service provider checks the balance of the public cryptocurrency address to verify whether it is locked (block 82). If the balance of the public cryptocurrency address is in the unlocked state, then the service provider initialize the balance of the public cryptocurrency address to the locked state (block 84), for example, by transferring a small amount of cryptocurrency to the public cryptocurrency address. The service provider checks the balance of the public cryptocurrency address (block 86), and if the balance is in the locked state (block 88), the service provider requests the user to unlock the secure area by modifying the balance using the private cryptocurrency key (block 90). Once the user modifies the balance of the public cryptocurrency address to reflect the unlocked state, the service provider enables access to the secure area of the online account (block 92).

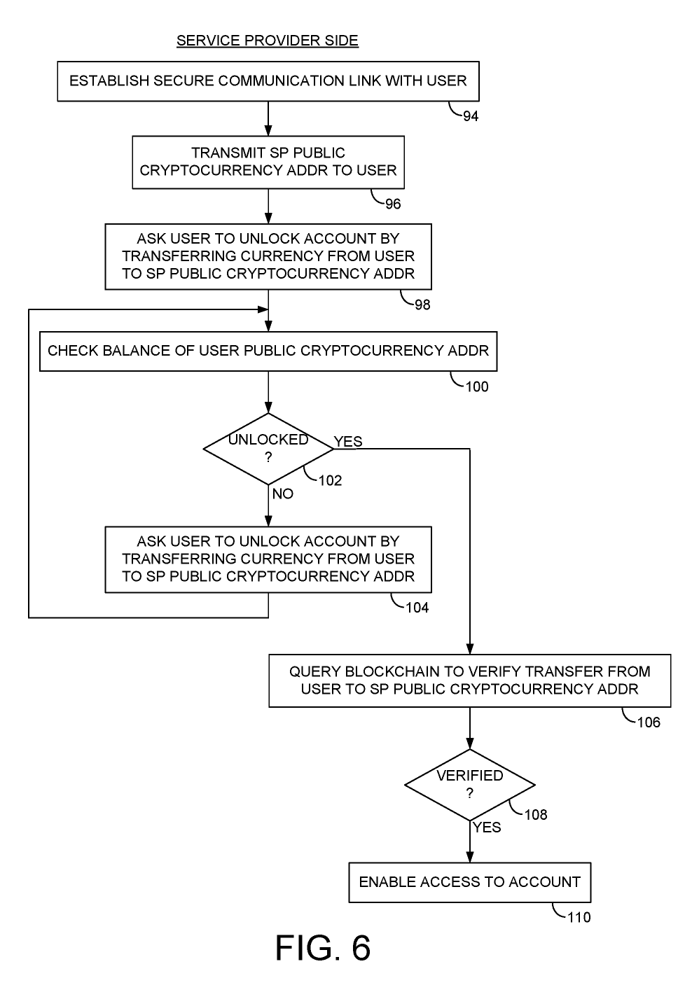

FIG. 6 is a flow diagram according to an embodiment executed at the service provider side of a computer network responsible for maintaining online accounts for users. This embodiment may be used to increase the security of the online account by requiring the user to modify the balance of a user's public cryptocurrency address associated with the account (and thereby unlock the account) by transferring currency from the user public cryptocurrency address to a public cryptocurrency address provided by the service provider. After establishing a secure communication link with the user (block 94), the service provider transmits a service provider (SP) public cryptocurrency address to the user (block 96) and asks the user to unlock the account by transferring currency from the user public cryptocurrency address to the SP public cryptocurrency address (block 98). In one embodiment, only the service provider and the user are aware of the SP public cryptocurrency address since it is transmitted to the user over the secure communication link (e.g., secure Internet link, secure cellular network link, etc.). The service provider checks the balance of the user public cryptocurrency address (block 100) and continues waiting for the user to execute the transfer (block 104) until the balance of the user public cryptocurrency address indicates it has been modified to the unlocked state (block 102). The service provider queries the blockchain database associated with the cryptocurrency in order to verify there was in fact a transfer from the user public cryptocurrency address to the SP public cryptocurrency address (block 106). If the blockchain verifies the transfer (block 108), the service provider enables access to a secure part (or feature) of the online account at block 110 (which may be the entire account).

The above-described embodiments may be implemented using any suitable computer system. In one embodiment, the flow diagrams shown in the figures may be implemented using a computer system comprising a microprocessor configured to execute steps of a computer program. In one embodiment, the steps of the computer program may be stored on a suitable, non-transient computer readable storage medium, such as a disk drive or a flash memory. In some embodiments, at least some blocks of the flow diagrams may be implemented using the Internet, and in other embodiments at least some blocks of the flow diagrams may be implemented using a cellular network. Other embodiments may employ both the Internet as well as a cellular network in order to implement the various blocks of the flow diagrams. For example, in one embodiment a user may access an online account through the Internet, wherein the public cryptocurrency addresses may be transmitted between the user and the service provider computers using a cellular network in order to increase the security of the system.

1. A method of managing an online account comprising:
receiving a public cryptocurrency address using a network of computers;
checking a balance associated with the public cryptocurrency address using an Internet; and
when the checked balance of the public cryptocurrency address is reduced, enabling access to at least part of the online account.

2. The method as recited in claim 1, wherein the public cryptocurrency address is a bitcoin address.

3. (canceled)

4. The method as recited in claim 1, wherein enabling access to the at least part of the online account comprises enabling a withdrawal of funds from the online account.

5. The method as recited in claim 1, wherein enabling access to the at least part of the online account comprises enabling access to a database associated with the online account.

6. The method as recited in claim 1, further comprising:
comparing the checked balance of the public cryptocurrency address to a target value; and
enabling access to the at least part of the online account based on the comparison.

7. The method as recited in claim 1, further comprising receiving the public cryptocurrency address from a user of the online account.

8. (canceled)

9. The method as recited in claim 1, wherein the network of computers comprises at least one of the Internet and a cellular network.

10. A computer configured to:
receive a public cryptocurrency address using a network of computers;
check a balance associated with the public cryptocurrency address using an Internet; and
when the checked balance of the public cryptocurrency address is reduced, enable access to at least part of an online account.

11. The computer as recited in claim 10, wherein the public cryptocurrency address is a bitcoin address.

12. (canceled)

13. The computer as recited in claim 10, wherein the computer is further configured to enable access to the at least part of the online account by enabling a withdrawal of funds from the online account.

14. The computer as recited in claim 10, wherein the computer is further configured to enable access to the at least part of the online account by enabling access to a database associated with the online account.

15. The computer as recited in claim 10, wherein the computer is further configured to:
compare the checked balance of the public cryptocurrency address to a target value; and
enable access to the at least part of the online account based on the comparison.

16. The computer as recited in claim 10, wherein the computer is further configured to receive the public cryptocurrency address from a user of the online account.

17. (canceled)

18. The computer as recited in claim 10, wherein the network of computers comprises at least one of the Internet and a cellular network.

19. The method as recited in claim 6, wherein the target value is zero.

20. The computer as recited in claim 15, wherein the target value is zero.

21. The method as recited in claim 1, further comprising checking whether the balance associated with the public cryptocurrency key has been reduced by checking whether there has been an outgoing transfer that would reduce the balance associated with the public cryptocurrency key.

22. The computer as recited in claim 10, wherein the computer is further configured to check whether the balance associated with the public cryptocurrency key has been reduced by checking whether there has been an outgoing transfer that would reduce the balance associated with the public cryptocurrency key.

23. The method as recited in claim 1, further comprising enabling access to the at least part of the online account when the checked balance of the public cryptocurrency address is reduced while a user of the online account is logged into the online account.

24. The computer as recited in claim 10, wherein the computer is further configured to enable access to the at least part of the online account when the checked balance of the public cryptocurrency address is reduced while a user of the online account is logged into the online account.
